(19) United States
(12) Patent Application Publication
(10) Pub. No.: US 2011/0035282 A1
(43) Pub. Date: Feb. 10, 2011

(54) Consumer Sensitive Electronic Billboards

(75) Inventors: Oliver Spatscheck, Randolph, NJ (US); Subhabrata Sen, New Providence, NJ (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/537,882

(22) Filed: Aug. 7, 2009

(51) Int. Cl. G06Q 30/00

(52) U.S. Cl. 705/14.58; 705/14.69; 705/14.71

(57) ABSTRACT

A method and system for advertising on an electronic billboard is capable of adapting over time to advertising criteria associated with actual viewers of the billboard. Mobile device users in a vicinity of the billboard are identified. User profiles indicative of fixed network and/or wireless network usage for the mobile device users are analyzed for pertinent advertising criteria. The predominant advertising criteria may be used to select the billboard content. The content may also be obtained via an auction for the billboard display and/or the advertising criteria.

### BACKGROUND

1. Field of the Disclosure

The present disclosure relates to billboard advertising and, more particularly, to consumer sensitive electronic billboards.

2. Description of the Related Art

An increasing number of billboards use dynamic displays to electronically present advertising to consumers. The content of the dynamic displays may be changed by a provider of electronic billboards.

### BRIEF DESCRIPTION OF THE DRAWINGS

FIG. 1 is a block diagram of selected elements of an embodiment of an electronic billboard system;

FIG. 2 is a block diagram of selected elements of an embodiment of an advertising system;

FIG. 3 is a block diagram of selected elements of an embodiment of a user profiling system;

FIG. 4 is a block diagram of selected elements of an embodiment of a computing device; and

FIG. 5 is a flow chart describing selected elements of an embodiment of a method for billboard advertising.

### DESCRIPTION OF EXEMPLARY EMBODIMENTS

In one aspect, a disclosed method of billboard advertising includes identifying mobile device users in a vicinity of an electronic billboard, and querying user profiles associated with the mobile device users to obtain advertising criteria pertinent to the mobile device users. Based on the advertising criteria, the method may further include generating content for displaying on the electronic billboard. The operation of identifying may include identifying mobile device users in a vicinity comprising locations from where the electronic billboard is visible. The operation of identifying may include identifying a location for at least one of the mobile device users and determining whether the identified location is within a predetermined distance from the electronic billboard. The identified location may be a predicted location.

In some embodiments, the operation of querying may include querying user profiles generated from information gathered by at least one of a fixed network service provider and a wireless network service provider. Querying the user profiles may include querying user profiles indicative of at least one of a user's home network usage, home television usage, and home telephone usage. At least one of the mobile device users may be identified with an account with at least one of the fixed network service provider and the wireless network service provider. Generating content comprises receiving offers for displaying content on the electronic billboard.

In certain embodiments, the operation of generating content may include receiving offers for displaying content on the electronic billboard. The offers may be received in response to an auction based on a number of mobile device users in the vicinity. The operation of querying may include weighting the user profiles according to a market segment criteria. The market segment criteria may be a user's purchasing power, income, income type, address, age, gender, employer, profession, ethnicity, wealth indicator, or a combination thereof.

In another aspect, a disclosed computing device for generating billboard advertising includes a processor, and memory media accessible to the processor, including processor executable instructions. The processor executable instructions may be executable to identify mobile devices in a vicinity of an electronic billboard, obtain profiles respectively associated with at least one of the mobile devices and users of the mobile devices, and based on the profiles, identify content for displaying on the electronic billboard.

In certain embodiments, the processor instructions to identify content may include processor instructions to determine advertising criteria based on the profiles, wherein the profiles describe a user's fixed network usage, home television usage, home telephone usage, wireless network usage, cellular telephone usage, or a combination thereof. The processor instructions to identify content may include processor instructions executable to generate a set of advertising topics based on the determined advertising criteria, select an advertising topic based on a number of profiles associated with each advertising topic in the set, and obtain multimedia content associated with the selected advertising topic. The multimedia content may be provided by an advertiser in response to outputting the advertising topic to the advertiser.

In particular embodiments, the computing device may include processor instructions to initiate display of the obtained multimedia content on the electronic billboard. The processor instructions to identify mobile devices may include processor instructions executable to in response to sending a request specifying a location of the electronic billboard, receive mobile device information for mobile devices in the vicinity, and use the mobile device information to determine respective identities for the mobile device users associated with the mobile devices. The mobile device information may be received from a wireless network service provider. The mobile device information may include location information.

In still another aspect, a disclosed service for advertising using an electronic billboard includes determining a user identity for at least one of a plurality of mobile device users in a vicinity of the electronic billboard, and identifying at least one advertising criteria associated with each user identity. The service may include determining a predominant advertising criteria from the identified advertising criteria, and based on the predominant advertising criteria, selecting content for display on the electronic billboard. The service may further include initiating display of the content on the electronic billboard.

In certain embodiments, the operation of identifying may include accessing a user profile associated with the user identity, and determining the advertising criteria based on information in the user profile. The user profile information may include usage information collected by at least one of: a fixed network service provider and a wireless network service provider. The usage information may include fixed network usage, home television usage, home telephone usage, wireless network usage, cellular telephone usage, or a combination thereof. The home network service provider and the cellular network service provider may represent a single business entity. The content may be selected for display over a predetermined time period. The content may be refreshed when a current time period elapses. During the current time period, the operation of determining a predominant advertising criteria may be performed with respect to a subsequent time period.

In the following description, details are set forth by way of example to facilitate discussion of the disclosed subject matter. It should be apparent to a person of ordinary skill in the field, however, that the disclosed embodiments are exemplary and not exhaustive of all possible embodiments.

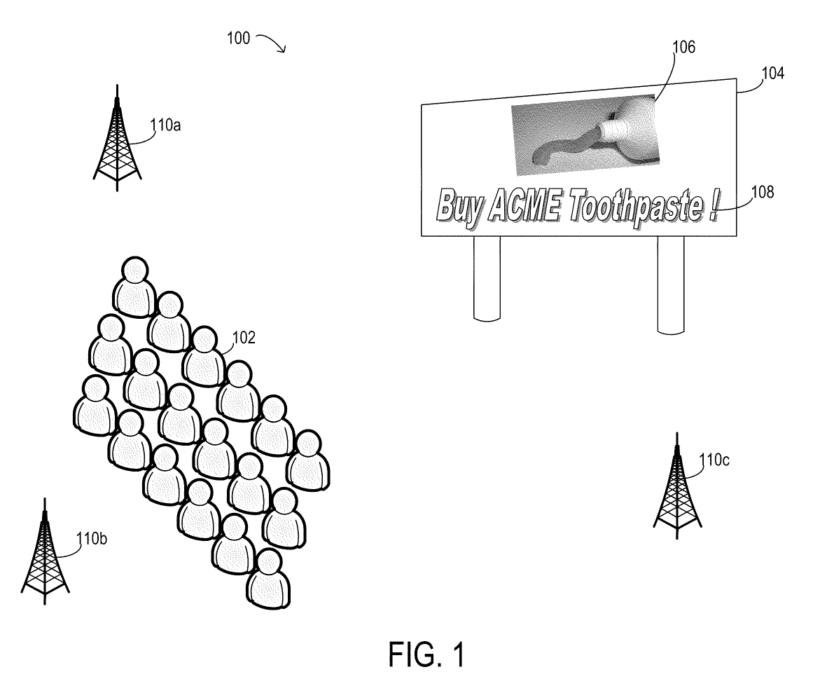

Referring now to FIG. 1, a block diagram of selected elements of an electronic billboard system 100 is illustrated. Elements in FIG. 1 are drawn figuratively for illustrative purposes and are not drawn to scale or to any particular perspective. Electronic billboard system 100 depicts interaction between a plurality of potential consumers, represented by mobile device users 102, and electronic billboard 104.

Electronic billboard 104 may be any type of dynamic display of various size and construction. Electronic billboard 104 may operate to display content, such as text, images, video or multimedia content. In one embodiment, electronic billboard 104 operates mechanically to display one of a number of possible static images. In another embodiment, electronic billboard 104 is a display device comprising an array of pixels for generating content, such as a light emitting diode (LED) or liquid crystal display (LCD) display. Electronic billboard 104 may also include a combination of mechanical and electrical components. As shown in FIG. 1, an exemplary embodiment of electronic billboard 104 may display advertising text element 108 and advertising image element 106, as desired. Electronic billboard 104 may include a network connection (not shown in FIG. 1), which may be configured to access a fixed and/or wireless network, for receiving commands and data representing content for display. Electronic billboard 104 may further include internal control systems for generating the display (not shown in FIG. 1).

Mobile device users 102 represent a plurality of consumers who possess and operate at least one mobile device, such as a cellular telephone or a portable media player. In the present discussion, it will be assumed that mobile device users 102 are in possession of a mobile device that is activated and in communication with a wireless network. In instances when mobile device users 102 carry more than one active mobile device, certain operations described herein applicable to an individual mobile device may be replicated for additional mobile devices. Mobile device users 102 may also at some time be located within a certain distance of electronic billboard 104. In a given vicinity, i.e., within a certain distance or a certain region, of electronic billboard 104, it may be assumed that electronic billboard 104 is visible. Mobile device users 102 may be identified as being within the vicinity of electronic billboard 104. It is noted that mobile device users 102 may be pedestrians or may be traveling in a vehicle. A location and velocity for at least one of mobile device users 102 may be determined and in some cases, may be used to predict a future location.

In FIG. 1, radio antennas 110a, 110b, 110c, represent exemplary transmitters for a wireless network providing signal coverage in the vicinity of electronic billboard 104. In one embodiment, radio antennas 110a, 110b, 110c are cellular network cell towers. Radio antennas 110a, 110b, 110c may be further coupled to base station controllers and network backbone systems (not shown in FIG. 1) for operating a wireless network communications system. In some embodiments, at least one of radio antennas 110a, 110b, 110c provide wireless network access to electronic billboard 104.

Any one or more of radio antennas 110a, 110b, 110c may provide coverage for mobile devices in the vicinity of electronic billboard 104. Radio antennas 110a, 110b, 110c may be operated by at least one wireless network provider (not shown in FIG. 1), with which at least one of mobile device users 102 has an account for wireless service for a mobile device. As will be described in detail below, the account for wireless services may be used to identify a mobile device user. Radio antennas 110a, 110b, 110c may further be configured to determine location information for mobile devices. The location information may be explicit, such as global-positioning system (GPS) coordinates transmitted from a mobile device, or may be implicit, such as signal triangulation (i.e., based on transmission time or signal intensity) using two or more antennas in communication with the mobile device. The location information may be time stamped and extrapolated to determine a velocity or to predict a future location for the mobile device.

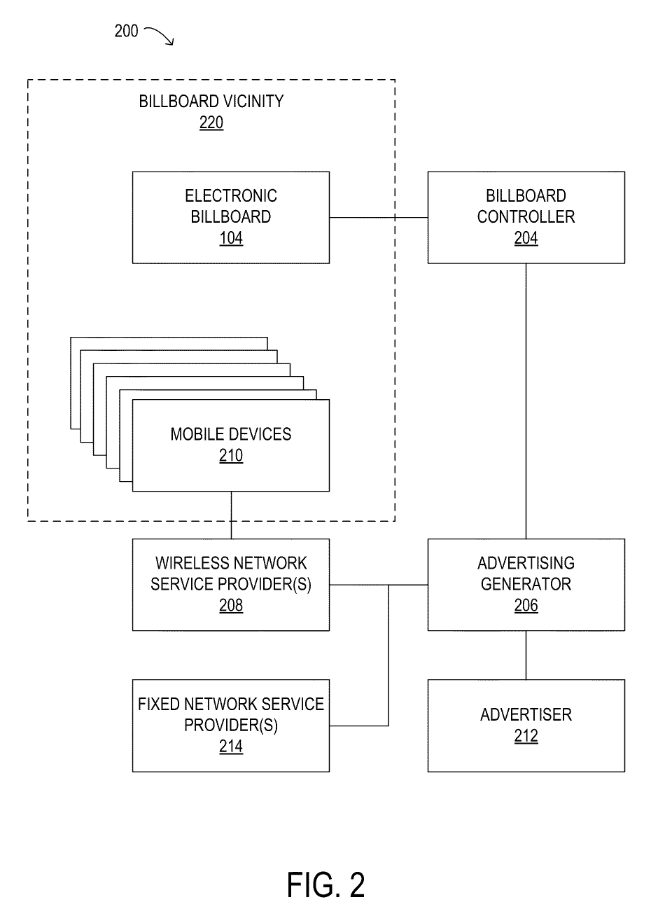

Turning now to FIG. 2, a block diagram of selected elements of an embodiment of advertising system 200 is illustrated. Advertising system 200 represents functional elements associated with electronic billboard system 100 (see FIG. 1). Functional elements are depicted as individual blocks for clarity, while it is noted that certain elements may be combined or integrated into a single device or functional element, as desired.

Billboard vicinity 220 represents a region near electronic billboard 104, which also includes a plurality of mobile devices 210. Mobile devices 210 are associated with a respective plurality of mobile device users, as described previously (see FIG. 1). Billboard controller 204 may control functionality of electronic billboard 104, and may provide content for display thereon. In one embodiment, billboard controller 204 receives content for display and transmits the content for display on electronic billboard 104. In certain implementations, billboard controller 204 may be configured to obtain specified content from an external source (not shown in FIG. 2), such as a data warehouse or a content provider. In some examples of advertising system 200, billboard controller 204 is configured to control and operate a plurality of electronic billboards, which may be installed at various geographic locations. In certain cases, billboard controller 204 may further be configured to combine adjacent billboards into a unified display spanning multiple billboards. Billboard display 204 may still further include ancillary functions related to operating electronic billboards, such as lighting control, monitoring, maintenance, reporting, billing, etc.

In FIG. 2, advertising generator 206 represents functionality for consumer sensitive electronic billboard control, as will be described in detail below. Advertising generator 206 may obtain a location of electronic billboard 104. Using the location as a reference, advertising generator 206 may request wireless network service provider(s) 208 for mobile device information for mobile devices in billboard vicinity 220. Wireless network service provider(s) 208 may return mobile device information and/or user identities to advertising generator 206. Advertising generator 206 may also use the mobile device information to obtain corresponding user identities. For example, the mobile device information may include cellular telephone numbers, which advertising generator 206 may look up in a reverse-phone directory to obtain respective user identities. The mobile device information may include location information for mobile devices 210.

It is noted that since electronic billboard 104 may be in a public venue, mobile devices 210 may be services by a number of individual wireless network service providers. Accordingly, wireless network service provider(s) 208 may represent a number of different wireless network services provided within billboard vicinity 220, with which advertising generator 206 may communicate.

Once the user identities corresponding to mobile devices 210 have been determined, advertising generator 206 may obtain various usage information for individual user identities, and then use the usage information to ascertain advertising criteria, as will be described further in detail. In particular, advertising generator 206 may obtain wireless usage information for user identities from wireless network service provider(s) 208, and may obtain fixed network usage information from fixed network service provider(s) 214.

The wireless usage information may describe at least one of wireless network usage and cellular phone usage. Wireless network usage may include any type of packet-based data communication, such as the transmission of text messages, web pages, images, videos, audio data, application data, data for Internet usage, and other multimedia content. Cellular phone usage may include voice signals and network data transmission performed using a cellular telephony device. In some embodiments, a mobile device may provide both wireless network and cellular phone functionality. Examples of wireless networks include wireless local area networks (LAN), metropolitan area networks (MAN), personal area networks (PAN), and other networks covered by IEEE 802 standards. Examples of cellular networks include the Global System for Mobile Communications (GSM) and code division multiple access (CDMA), and variations thereof, among others.

The fixed network usage information may describe at least one of home network usage, home television (TV) usage and home telephone usage. Fixed network usage may generally be associated with network services provided to a private residence of a mobile device user. Home network usage may include any type of packet-based data communication, such as the transmission of text messages, web pages, images, videos, audio data, application data, data for Internet usage, and other multimedia content. Home network usage may generally be associated with computer systems that a mobile device user maintains and operates at a private residence, such as provided by an Internet service provider (ISP). Home TV usage may generally be associated with multimedia content provided by a multimedia content distribution network (MCDN), or other content providers, such as cable or satellite providers, to the private residence. For example, Internet protocol television (IPTV) is an example of home TV usage that may be monitored by a fixed network service provider. Home telephone usage may generally be associated with voice communications from a fixed telephone service provided to the private residence. It is noted that with ascendancy of digital networking to the home, overlap in the fixed network services between home network usage, home TV usage, and home telephone usage may be expected. For example, a home telephone service may be provided as a voice-over IP (VOIP) using a common network connection with home network services.

In FIG. 2, advertising generator 206 may provide wireless network service provider(s) 208 with a user identity, and obtain in return a first user profile, including wireless usage information, describing wireless usage associated with the user identity. Further, advertising generator 206 may provide fixed network service provider(s) 214 with the user identity, and obtain in return a second user profile, including fixed network usage information, describing fixed network usage associated with the user identity. The first and second user profiles may be mined by advertising generator 206 to determine pertinent or relevant advertising criteria associated with the user identity. Advertising generator 206 may determine at least one advertising criteria for each user identity.

Similarly, first and second user profiles may be obtained by advertising generator 206 for a number of user identities associated with mobile devices 210. This may result in generating a set of advertising criteria associated with mobile devices 210 located in billboard vicinity 220. Each advertising criteria may be indicative of a number of user identities, such that the advertising criteria may be ranked by the number of users associated therewith. In certain embodiments, the advertising criteria for the largest number of user identities (generally referred to as a voting method) may be selected by advertising generator 206 as the most pertinent advertising criteria for electronic billboard 104. Then, advertising generator 206 may obtain content corresponding to the most pertinent advertising criteria for display on billboard 104.

In some instances, additional or other methods may be used to determine advertising criteria for electronic billboard 104. For example, the user identities may be weighted according to a market segment criteria, in order to increase market relevance of the rankings. The market segment criteria may be at least one of a user's purchasing power, income, income type, address, age, gender, employer, profession, ethnicity, wealth indicator or a combination thereof. A wealth indicator may include information about lifestyle, purchasing habits, spending choices, investment choices, affiliations, memberships, etc.

In certain cases, specific market segment criteria relevant to a particular advertiser, such as advertiser 212, may be selected. For example, advertiser 212 may desire determining which mobile device users 102 are currently its customers, as well as potential customers. Advertiser 212 may also supply advertising generator 206 with market segment criteria or with advertising criteria for matching with mobile device users 102.

Advertising generator 206 may still further instigate an auction to sell advertising space on electronic billboard 104. In one example, advertising generator 206 determines a set of advertising topics based on user profiles (based on fixed and/or wireless network usage) for mobile device users 102. The advertising topics are then offered in a real-time auction to at least one advertiser, such as advertiser 212, who is permitted to bid on the advertising topics. Advertising generator 206 may then select the highest bid for a particular advertising topic from a particular advertiser. The benefit for the advertiser is the opportunity to place a specific ad to a targeted audience, as determined in real-time.

As described above, advertising generator 206 may determine the most pertinent content for electronic billboard 104. Advertising generator 206 may further obtain the content and initiate display of the content on electronic billboard 104. The content may also be obtained, or provided by, advertiser 212 and sent to advertising generator 206. Advertiser 212 may itself be a vendor of products and/or services described in the content. In some embodiments, advertiser 212 represents the vendor in providing advertising services. In some cases, advertising generator 206 may specify the content to billboard controller 204, which then may obtain the content from an external source (not shown in FIG. 2) and then may cause the content to be displayed on electronic billboard 104.

The methods described above, such as identifying mobile devices 210, obtaining user profiles, determining advertising criteria, and displaying content on electronic billboard 104, among others, may be continuously performed and repeated in real-time. The current content selected for display on electronic billboard 104 may be displayed for a predetermined time period. While the current content is displayed, the method operations for determining the subsequent content may be performed. The predetermined time period may be constant or may itself vary in duration over time. In this manner, the content displayed on electronic billboard 104 may be effectively adapted to an actual viewing audience, which may change over time. Such a capability for adaptation may enhance the economic value of electronic billboard 104.

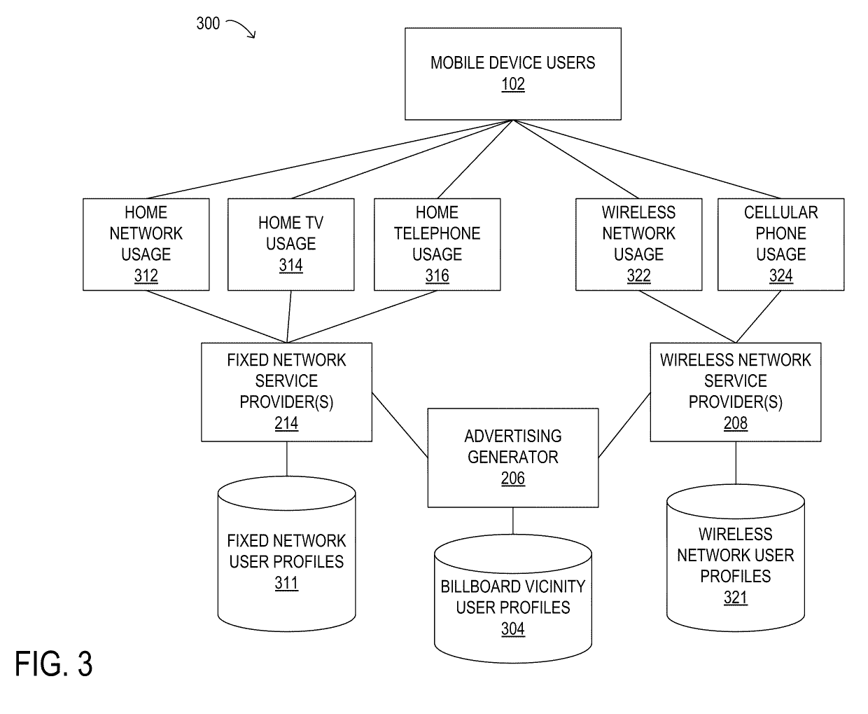

Turning now to FIG. 3, a block diagram of selected elements of an embodiment of user profiling system 300 is illustrated. Mobile device users 102 may be identified in the vicinity of electronic billboard 104, as described above. Mobile device users 102 also represent consumers who use at least one mobile device and who may have an account for fixed network services at a place of residence. Accordingly, mobile device users 102 may be associated with the usage of a fixed network and a wireless network.

The usage of fixed network resources may include home network usage 312, home TV usage 314, and home telephone usage 316. The usages 312, 314, 316 may be tracked by at least one fixed network service provider(s) 214 and recorded as fixed network user profiles 311. User profiles 311 may contain a profile for each individual user (or user account), along with information describing fixed network activity and interaction. For example, a data source for home network usage 312 may be deep-packet inspection (DPI) of Internet activity provided by an ISP. Similarly, TV viewing data may provide the basis for home TV usage 314, while call detail information may provide data for home telephone usage 316.

The usage of wireless network resources may include wireless network usage 322 and cellular phone usage 324. The usages 322, 324 may be tracked by at least one wireless network service provider(s) 208 and recorded as wireless network user profiles 321. It is noted that certain mobile devices may provide combinations of wireless network usage 322 and cellular phone usage 324. User profiles 321 may contain a profile for each individual user (or user account), along with information describing wireless network activity and interaction. For example, a data source for wireless network usage 322 may be DPI of Internet activity using a mobile device. Similarly, call detail information may provide data for cellular telephone usage 324.

In FIG. 3, advertising generator 206 may obtain first user profiles from fixed network service provider(s) 214, based on fixed network user profiles 311. Advertising generator 206 may also obtain second user profiles from wireless network service provider(s) 208, based on wireless network user profiles 321. Advertising generator 206 may combine the first and second user profiles for particular user identities and generate billboard vicinity user profiles 304. Billboard vicinity user profiles 304 may be used by advertising generator 206 to determine advertising criteria and select content for display on electronic billboard 104. It is noted that as the particular individuals in the vicinity of electronic billboard 104 change over time, advertising generator 206 may retrieve additional first and second user profiles, as desired. In certain embodiments, advertising generator 206 may update existing profiles stored in billboard vicinity user profiles 304.

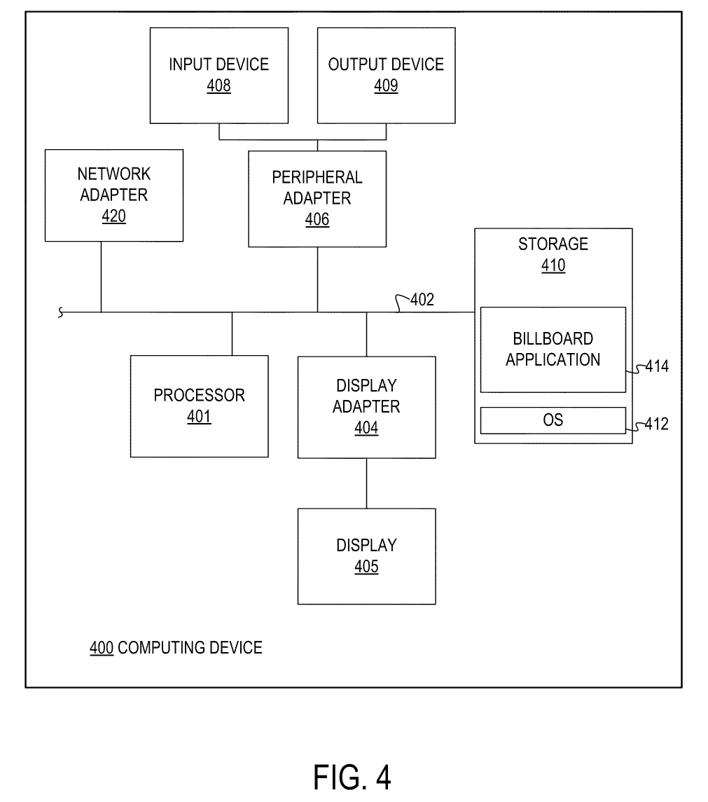

Referring now to FIG. 4, a block diagram illustrating selected elements of an embodiment of a computing device 400 is presented. In the embodiment depicted in FIG. 4, device 400 includes processor 401 coupled via shared bus 402 to storage media collectively identified as storage 410.

Device 400, as depicted in FIG. 4, further includes network adapter 420 that interfaces device 400 to a network (not shown in FIG. 4). In embodiments suitable for use in server deployment, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as an LCD screen, a computer monitor, a television or the like. Display 405 may comply with a display standard for the corresponding type of display. Standards for computer monitors include analog standards such as video graphics array (VGA), extended graphics array (XGA), etc., or digital standards such as digital video interface (DVI), high definition multimedia interface (HDMI), among others. A television display may comply with standards such as National Television System Committee (NTSC), Phase Alternating Line (PAL), or another suitable standard. Display 405 may include an output device 409, such as one or more integrated speakers to play audio content, or may include an input device 408, such as a microphone or video camera.

Storage 410 encompasses persistent and volatile media, fixed and removable media, and magnetic and semiconductor media. Storage 410 is operable to store instructions, data, or both. Storage 410 as shown includes sets or sequences of instructions, namely, an operating system 412, and billboard application 414. Operating system 412 may be a UNIX or UNIX-like operating system, a Windows® family operating system, or another suitable operating system.

It is noted that in some embodiments device 400 represents a computing device used by advertising generator 206, shown in FIG. 2. In some cases, billboard application 414 may be configured to provide functionality described in process 200 (see FIG. 2).

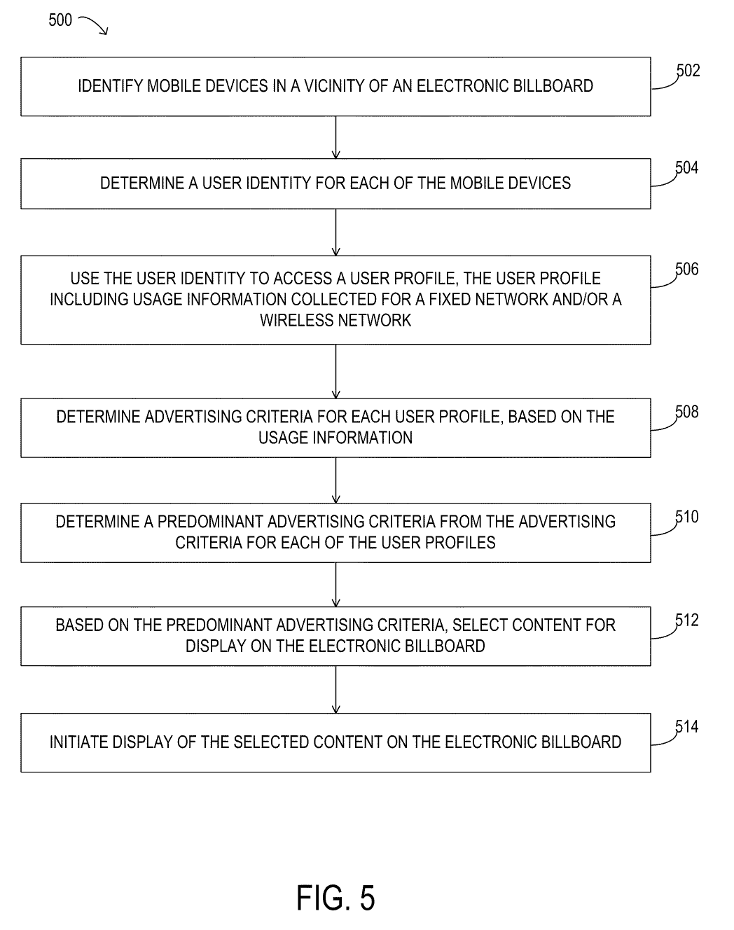

Turning now to FIG. 5, a flow chart describing selected elements of an embodiment of method 500 for billboard advertising is shown. Mobile devices in a vicinity of an electronic billboard may be identified (operation 502). One or more wireless network service providers may provide identification of their respectively serviced mobile devices. A user identity for each of the mobile devices may be determined (operation 504). The user identity may be an identifier, such as a telephone number, email address, account number, etc., which is usable in a database query. Then, the user identity may be used to access a user profile, the user profile including usage information collected for a fixed network and/or a wireless network (operation 506). The user profile may correspond to billboard vicinity user profiles 304, as described above (see FIG. 3). Advertising criteria for each user profile, based on the usage information may be determined (operation 508). The user profile may be mined for usage data indicative of advertising criteria.

Next, a predominant advertising criteria from the advertising criteria for each of the user profiles may be determined (operation 510). A voting method may be used to generate rankings for advertising criteria. In some cases, a weighting based on market segment criteria may be applied to the user profiles. Based on the predominant advertising criteria, content for display on the electronic billboard may be selected (operation 512). The content may be multimedia content, such as text, images, videos, etc. Then, display of the selected content may be initiated on the electronic billboard (operation 514). It is noted that at least some portions of method 500 may be repeated over time to continuously adapt the displayed content to advertising criteria associated with actual viewers of the electronic billboard.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method of billboard advertising, comprising:
identifying mobile device users in a vicinity of an electronic billboard;
querying user profiles associated with the mobile device users to obtain advertising criteria pertinent to the mobile device users; and
based on the advertising criteria, generating content for displaying on the electronic billboard.

2. The method of claim 1, wherein said identifying comprises identifying mobile device users in a vicinity comprising locations from where the electronic billboard is visible.

3. The method of claim 1, wherein said identifying comprises identifying a location for at least one of the mobile device users and determining whether the identified location is within a predetermined distance from the electronic billboard.

4. The method of claim 3, wherein the identified location is a predicted location.

5. The method of claim 1, wherein said querying further comprises:
querying user profiles generated from information gathered by at least one of a fixed network service provider and a wireless network service provider.

6. The method of claim 5, wherein querying the user profiles further comprises:
querying user profiles indicative of at least one of a user's home network usage, home television usage, and home telephone usage.

7. The method of claim 5, wherein querying the user profiles further comprises:
querying user profiles indicative of at least one of a user's wireless network usage and cellular telephone usage.

8. The method of claim 5, wherein at least one of the mobile device users are identified with an account with at least one of the fixed network service provider and the wireless network service provider.

9. The method of claim 1, wherein said generating content further comprises:
receiving offers for displaying content on the electronic billboard.

10. The method of claim 9, wherein the offers are received in response to an auction based on a number of mobile device users in the vicinity.

11. The method of claim 1, wherein said querying further comprises:
weighting the user profiles according to a market segment criteria.

12. The method of claim 11, wherein the market segment criteria is at least one of a user's purchasing power, income, income type, address, age, gender, employer, profession, ethnicity and wealth indicator.

13. A computing device for generating billboard advertising, comprising:
a processor; and
memory media accessible to the processor, including processor executable instructions to:
identify mobile devices in a vicinity of an electronic billboard;
obtain profiles respectively associated with at least one of the mobile devices and users of the mobile devices; and
based on the profiles, identify content for displaying on the electronic billboard.

14. The computing device of claim 13, wherein said processor instructions to identify content further comprise processor instructions to:
determine advertising criteria based on the profiles, wherein the profiles describe at least one of a user's fixed network usage, home television usage, home telephone usage, wireless network usage, and cellular telephone usage.

15. The computing device of claim 14, wherein said processor instructions to identify content further comprise processor instructions executable to:
generate a set of advertising topics based on the determined advertising criteria;
select an advertising topic based on a number of profiles associated with each advertising topic in the set; and
obtain multimedia content associated with the selected advertising topic.

16. The computing device of claim 15, wherein the multimedia content is provided by an advertiser in response to outputting the advertising topic to the advertiser.

17. The computing device of claim 13, further comprising processor instructions to:
initiate display of the obtained multimedia content on the electronic billboard.

18. The computing device of claim 13, wherein said processor instructions to identify mobile devices further comprise processor instructions executable to:
in response to sending a request specifying a location of the electronic billboard, receive mobile device information for mobile devices in the vicinity; and
use the mobile device information to determine respective identities for the mobile device users associated with the mobile devices.

19. The computing device of claim 18, wherein the mobile device information is received from a wireless network service provider.

20. The computing device of claim 19, wherein the mobile device information includes location information.

21. A service for advertising using an electronic billboard, comprising:
determining a user identity for at least one of a plurality of mobile device users in a vicinity of the electronic billboard;
identifying at least one advertising criteria associated with each user identity;
determining a predominant advertising criteria from the identified advertising criteria; and
based on the predominant advertising criteria, selecting content for display on the electronic billboard.

22. The service of claim 21, further comprising:
initiating display of the content on the electronic billboard.

23. The service of claim 21, wherein said identifying further comprises:
accessing a user profile associated with the user identity; and
determining the advertising criteria based on information in the user profile, wherein the user profile information includes usage information collected by at least one of: a fixed network service provider and a wireless network service provider.

24. The service of claim 23, wherein the usage information includes at least one of: fixed network usage, home television usage, home telephone usage, wireless network usage, and cellular telephone usage.

25. The service of claim 23, wherein the home network service provider and the cellular network service provider represent a single business entity.

26. The service of claim 21, wherein the content is selected for display over a predetermined time period.

27. The service of claim 21, wherein said content is refreshed when a current time period elapses, and wherein, during the current time period, said determining a predominant advertising criteria is performed with respect to a subsequent time period.
